(19) United States
(12) Patent Application Publication
(10) Pub. No.: US 2018/0297426 A1
(43) Pub. Date: Oct. 18, 2018

(54) VEHICLE TOWING DEVICE

(71) Applicant: Monster Hooks Inc., San Jose, CA (US)

(72) Inventors: Marco NAJARRO, San Jose, CA (US); Donna MEDVED, San Jose, CA (US)

(21) Appl. No.: 15/488,346

(22) Filed: Apr. 14, 2017

(51) Int. Cl. B60D 1/167; B60D 1/18; B60D 1/36

(52) U.S. Cl. CPC B60D 1/167; B60P 3/12; B60D 1/363; B60D 1/187

(57) ABSTRACT

Disclosed is a vehicle towing device. The device includes an elongate central body having a first end portion including a first mounting point and a second end portion, opposite to the first end portion, including a second mounting point. The device also includes a pair of hooks extending from the second end portion of the elongate central body.

### TECHNICAL FIELD

The present disclosure relates generally to vehicles and, more particularly to, vehicle towing devices.

### BACKGROUND

Vehicles are typically configured to have attachment points using which the vehicles can be towed in their broken states. Typically, a recovery vehicle may be used for towing such broken vehicles. The recovery vehicle generally includes a towing device, which may be coupled to one end of a towing strap and other end of the towing strap may be coupled to an attachment point of the broken vehicle to be towed. Generally, such towing device of the recovery vehicle includes a single towing hook operable to be attached to the broken vehicle to be towed.

However, such towing devices suffer from various problems; for example, such towing devices essentially require safety latches for locking a looped end of a towing strap to such towing device. Further, the towing devices can be used only for towing a single broken vehicle at a time. Furthermore, the towing devices can be suitably mounted to a very limited portion or part of a recovery vehicle. Moreover, the towing devices due to their structural configuration are capable of handing very small towing loads.

In light of the foregoing discussion, there exists a need to overcome the aforementioned drawbacks of conventional towing devices for recovery vehicle.

### SUMMARY

Various embodiments of the present disclosure provide vehicle towing devices.

In an embodiment, a vehicle towing device is disclosed. The device includes an elongate central body having a first end portion including a first mounting point and a second end portion, opposite to the first end portion, including a second mounting point. The device also includes a pair of hooks extending from the second end portion of the elongate central body.

In another embodiment, a vehicle towing device is disclosed. The device includes an elongate central body having a first end portion including a first mounting point and a second end portion, opposite to the first end portion, including a second mounting point. The device also includes a pair of hooks extending from the second end portion of the elongate central body. The device further includes a pair of safety latches movably arranged on the elongate central body and operable to close or open the pair of hooks.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 is perspective view of a vehicle towing device, in accordance with an example embodiment; and

FIGS. 2 and 3 are perspective views of the vehicle towing device of FIG. 1 in utilized states, in accordance with various example embodiments.

### The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

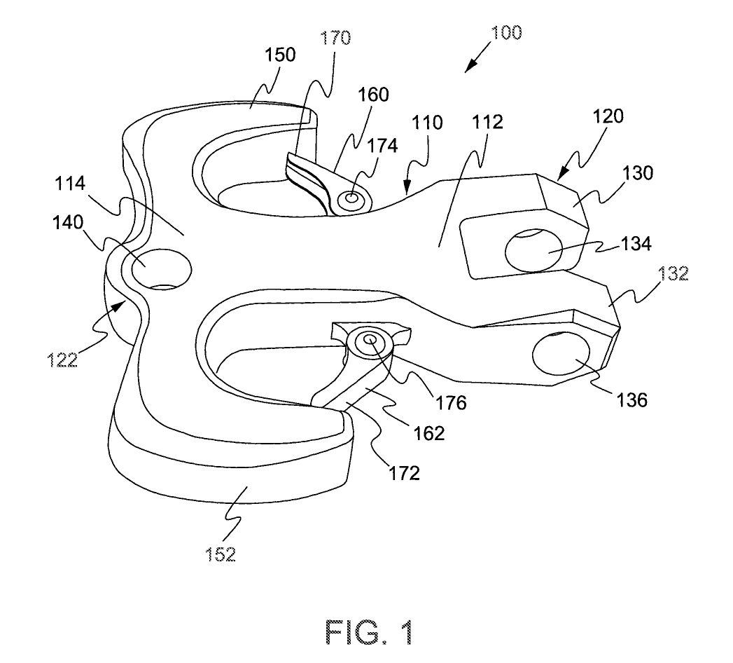

Referring now to the drawings, FIG. 1 is a perspective view of a vehicle towing device 100, in accordance with an example embodiment. As shown, the device 100 includes an elongate central body 110 having a first end portion 112 and a second end portion 114, opposite to the first end portion 112. Further, the first end portion 112 includes a first mounting point 120, and the second end portion 114 includes a second mounting point 122.

The first mounting point 120 includes a pair of spaced apart mounting tabs 130, 132. Further, each of the mounting tabs 130, 132 includes a mounting hole, such as holes 134, 136, respectively. As shown, the mounting tabs 130, 132 are substantially rectangular tabs and parallely spaced apart from each other. Furthermore, the holes 134, 136 of the mounting tabs 130, 132, respectively are longitudinally aligned to each other. Additionally, as shown, the second mounting point 122 includes a mounting hole 140.

The device 100 also includes a pair of hooks 150, 152 extending from the second end portion 114 of the elongate central body 110. In an embodiment, the pair of hooks 150, 152 is integral with the elongate central body 110. As shown, the pair of hooks 150, 152 are arcuate structures, i.e. extending from the second end portion 114 towards the elongate central body 110 to form hook-like structures.

The device 100 further includes a pair of safety latches 160, 162 movably arranged on the elongate central body 110. The pair of safety latches 160, 162 is operable to close or open the pair of hooks 150, 152. As shown, each of the pair of safety latches 160, 162 includes a free end, such as free ends 170, 172, respectively. Each of the pair of safety latches 160, 162 also includes a coupled end, such as coupled ends 174, 176, respectively. The coupled ends 174, 176 of the safety latches 160, 162 are pivotally (movably) coupled to a central portion (between the first and second end portions 112, 114) of the elongate central body 110. Further, the free ends 170, 172 of the safety latches 160, 162 can retractably move with respect to the coupled ends 174, 176. In an example, each of the pair of latches 160, 162 may include a spring (not shown) that enables in providing retractably pivotal movement to the free ends 170, 172 of the pair of latches 160, 162. Accordingly, the pair of latches 160, 162 is operable to close or open the pair of hooks 150, 152, particularly, the safety latches 160, 162 along with the hooks 150, 152 form close loops and open loops.

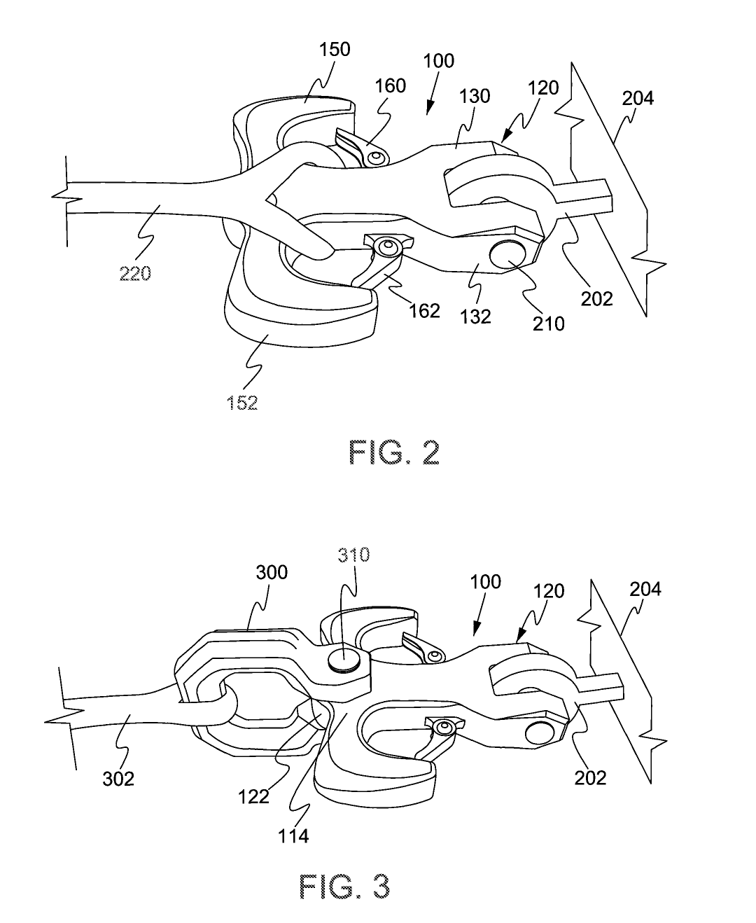

Referring now to FIGS. 2 and 3, illustrated are perspective views of the vehicle towing device 100 of FIG. 1 in utilized states, in accordance with various example embodiments. Specifically, as shown in FIG. 2, the first mounting point 120 is operable to be coupled to a mounting point 202 of a towing vehicle (for example, a recovery vehicle, not shown). It is to be understood that, the mounting point 202 may be a winch thimble arranged on front such as a front frame 204 of the towing vehicle. Further, in use, the mounting hole 134, 136 (shown in FIG. 1) of each of the mounting tabs 130, 132 is operable to receive a mounting rod 210 therethrough for coupling the mounting tabs 130, 132 with the mounting point 202 of the towing vehicle. Specifically, the mounting point 202 (i.e. the winch thimble) is aligned and positioned between the mounting tabs 130, 132 such that the mounting rod 210 can pass through the mounting point 202 and the mounting tabs 130, 132 for coupling the first mounting point 120 with the mounting point 202 of the towing vehicle.

Further, as shown in FIGS. 2 and 3, in use, at least one of the pair of hooks 150, 152 and the second mounting point 122 are operable to be coupled to at least one towing strap configured to be coupled to a mounting point of at least one vehicle to be towed (for example a broken vehicle). Specifically, as shown in FIG. 2, the pair of hooks 150, 152 is operable to be coupled to a towing strap 220 configured to be coupled to a mounting point of a vehicle to be towed (not shown). For example, the towing strap 220 at its one end may be coupled to a towing hook (not shown) arranged on a front of the vehicle to be towed. Further, as shown, another end of the towing strap 220 is looped around both the hooks 150, 152 and is locked thereto. This eliminates a need for essentially having the safety latches 160, 162 for locking looped end of the towing strap 220 to the device 100. Although, the safety latches 160, 162 can provide additional locking safety for the towing strap 220. Accordingly, the device 100 coupled to a recovery vehicle enables in towing a broken vehicle using the towing strap 220.

Referring now to FIG. 3, the second mounting point 122 is operable to be coupled to a shackle 300 for mounting a towing strap 302 thereon. As shown, the mounting hole 140 (shown in FIG. 1) of the second mounting point 122 enables in coupling the shackle 300 with the second mounting point 122 by receiving a mounting rod 310 therethrough. Specifically, the shackle 300 is coupled to the mounting hole 140 of the second end portion 114 of the elongate central body 110 using the mounting rod 310, and the shackle 300 is further coupled to the towing strap 302. Moreover, the first mounting point 120 is coupled to the mounting point 202 (such as the winch thimble) arranged on the front (such as the front frame 204) of the towing vehicle, as explained in FIG. 2. This enables the device 100 coupled to a recovery vehicle in towing a broken vehicle using the towing strap 302.

According to an embodiment, the device 100 may enable in simultaneously towing multiple vehicles (for example 3 vehicles) at a same time, i.e. by using multiple towing points provided by the device 100, such as the pair of hooks 150, 152, and the second mounting point, i.e. with the help of the shackle 300. Further, in one embodiment, the elongate central body 110 and the pair of hooks 150, 152 are made of one of metal, plastic, rubber or any combination thereof. For example, the elongate central body 110 and the pair of hooks 150, 152 may be made of stainless steel.

Embodiments of the present disclosure substantially eliminate or at least partially address the aforementioned problems in the background, and provide an improved vehicle towing device. The vehicle towing device may be used as a vehicle recovery hook in a recovery vehicle. The vehicle towing device of the present disclosure may enable in simultaneously towing multiple vehicles (for example 3 vehicles) at a same time, i.e. by using multiple towing points, such as the pair of hooks and the second mounting point. Further, the vehicle towing device of the present disclosure eliminates a need for essentially having safety latches, as the towing strap can be looped around both the hooks and can be locks thereto. Furthermore, the vehicle towing device of the present disclosure can be suitably mounted to a various parts of a recovery vehicle, for example a bumper, a hitch, a winch, a winch thimble and so forth. Moreover, the vehicle towing device of the present is capable of handing substantial towing load due its structural configuration, such as the elongate central body and the pair of hooks.

The embodiments illustrated and described herein as well as embodiments not specifically described herein but within the scope of aspects of the invention constitute exemplary vehicle towing device.

The benefits and advantages described above may relate to one embodiment or may relate to several embodiments. The embodiments are not limited to those that solve any or all of the stated problems or those that have any or all of the stated benefits and advantages.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A vehicle towing device, the device comprising:
an elongate central body comprising a first end portion having a first mounting point and a second end portion, opposite to the first end portion, having a second mounting point,
wherein the first mounting point includes a pair of spaced apart mounting tabs, each of the mounting tabs includes a mounting hole, wherein the mounting hole of each of the pair of mounting tabs is operable to receive a mounting rod therethrough for coupling the mounting tabs with a mounting point of a towing vehicle;
a shackle;
a pair of hooks extending from the second end portion of the elongate central body, wherein the second mounting point includes exactly one mounting hole located at intersection of the pair of hooks and the elongated central body such that the mounting hole is not higher than height of the pair of hooks and such that the mounting hole, the pair of hooks, and the elongated central body have same thickness, the elongated central body for coupling the shackle with the second mounting point, by receiving another mounting rod therethrough, the mounting rod once received in the mounting hole of each of the pair of mounting tabs being perpendicular to the another mounting rod when received in the exactly one mounting hole of the second mounting point, wherein at least one of the pair of hooks and the second mounting point is operable to be coupled to at least one towing strap configured to be coupled to a mounting point of at least one vehicle to be towed; and
a pair of safety latches movably arranged on the elongate central body and operable to close or open the pair of hooks, wherein the pair of safety latches touch inner surface of the pair of hooks, the inner surface of the pair of hooks facing towards the elongated central body.

2. (canceled)

3. The device as claimed in claim 12, wherein each of the pair of safety latches includes a free end and a coupled end.

4. The device as claimed in claim 3, wherein the coupled end of each of the pair of safety latches is pivotally coupled to a central portion of the elongate central body for allowing the free end of each of the pair of safety latches to retractably move with respect to the coupled end, the pair of safety latches comprising spring to enable the movement.

5. (canceled)

6. (canceled)

7. (canceled)

8. (canceled)

9. The device as claimed in claim 1, and further comprising a winch thimble aligned and positioned between the mounting tabs such that the mounting rod passes through the winch thimble and the mounting tabs.

10. The device as claimed in claim 1 and further comprising three vehicles, to be towed, connected to the pair of hooks and the another mounting hole such that the towing strap of a vehicle connected to the pair of hooks does not pass through the another mounting hole and another vehicle is connected using the another mounting hole.

11. The device as claimed in claim 1, wherein the elongate central body and the pair of hooks are made of one of metal, plastic, rubber or any combination thereof.

12. (canceled)

13. (canceled)

14. (canceled)

15. (canceled)

16. (canceled)

17. (canceled)

18. (canceled)

19. (canceled)

20. (canceled)

21. A vehicle towing device, the device comprising:
an elongate central body comprising a first end portion having a first mounting point and a second end portion, opposite to the first end portion, having a second mounting point, wherein the first mounting point includes a pair of spaced apart mounting tabs, each of the mounting tabs includes a mounting hole, wherein the mounting hole of each of the pair of mounting tabs is operable to receive a mounting rod there through for coupling the mounting tabs with a mounting point of a towing vehicle;
a shackle;
a pair of hooks extending from the second end portion of the elongate central body, wherein the second mounting point includes exactly one mounting hole located at intersection of the pair of hooks and the elongated central body such that the mounting hole is not higher than height of the pair of hooks and such that the mounting hole, the pair of hooks, and the elongated central body have same thickness, the elongated central body for coupling a shackle with the second mounting point, by receiving another mounting rod there through, the mounting rod once received in the mounting hole of each of the pair of mounting tabs being perpendicular to the another mounting rod when received in the exactly one mounting hole of the second mounting rod when received in the exactly one mounting hole of the second mounting point, wherein at least one of the pair of hooks and the second mounting point is operable to be coupled to at least one towing strap configured to be coupled to a mounting point of at least one vehicle to be towed; and
a pair of safety latches movably arranged on the elongate central body and operable to close or open the pair of hooks, wherein the pair of safety latches touch inner surface of the pair of hooks, the inner surface of the pair of hooks facing towards the elongated central body wherein each of the pair of safety latches includes a free end and a coupled end, wherein the coupled end of each of the pair of safety latches is pivotally coupled to a central portion of the elongate central body for allowing the free end of each of the pair of safety latches to retractably move with respect to the coupled end, the pair of safety latches comprising spring to enable the movement.
